(19) United States
(12) Patent Application Publication
(10) Pub. No.: US 2025/0112646 A1
(43) Pub. Date: Apr. 3, 2025

(54) THROUGH RECEIVE PATH FOR MULTIPLEXING BANDS IN CARRIER AGGREGATION

(71) Applicant: SKYWORKS SOLUTIONS, INC., Irvine, CA (US)

(72) Inventor: Stephane Richard Marie Wloczysiak, Irvine, CA (US)

(21) Appl. No.: 18/822,589

(22) Filed: Sep. 3, 2024

Related U.S. Application Data
(60) Provisional application No. 63/542,122, filed on Oct. 3, 2023.

(51) Int. Cl. H04B 1/00; H04L 5/14

(52) U.S. Cl. CPC H04B 1/0057; H04L 5/1461

(57) ABSTRACT

A radio frequency multiplexer including a signal node to receive and/or transmit radio frequency signals, a first signal processing component to pass frequencies in a first band and reject frequencies in a second band, a second signal processing component to pass frequencies in the second band and reject frequencies in the first band, and a coupling circuit. The coupling circuit is coupled to the signal node and the first and second signal processing components and configured to couple the first signal processing component and the second signal processing component to the common signal node and in parallel with one another in a first mode, and to couple only the second signal processing component to the signal node in a second mode with the second signal processing component being coupled in series with the first signal processing component between the first signal processing component and the signal node.

### CROSS-REFERENCE TO RELATED APPLICATIONS

This application claims priority under 35 U.S.C. § 119(e) to U.S. Provisional Patent Application Ser. No. 63/542,122 titled “THROUGH RECEIVE PATH FOR MULTIPLEXING BANDS IN CARRIER AGGREGATION,” filed Oct. 3, 2023, the entire contents of which is incorporated herein by reference for all purposes.

### BACKGROUND

### 1. Field of the Disclosure

The present disclosure relates to multiplexers and related circuits for radio-frequency (RF) applications.

### 2. Description of the Related Art

In radio-frequency (RF) applications, a signal having a plurality of frequency components can be routed from a common path to separate paths. In reverse, a plurality of signals can be routed from respective paths to a common path. Either or both of such functionalities allow, for example, carrier aggregation of a plurality of RF signals.

### SUMMARY

According to an aspect of the present disclosure, a radio frequency multiplexer is provided. The radio frequency multiplexer comprises a common signal node to receive and/or transmit radio frequency signals, a first signal processing component configured to pass frequencies in a first band and to reject frequencies in a second band, a second signal processing component configured to pass frequencies in the second band and to reject frequencies in the first band, and a coupling circuit. The coupling circuit is coupled to the common signal node and the first and second signal processing components and configured to couple the first signal processing component and the second signal processing component to the common signal node and in parallel with one another in a first mode of operation, and to couple only the second signal processing component to the common signal node in a second mode of operation with the second signal processing component being coupled in series with the first signal processing component between the first signal processing component and the common signal node.

In one example, the first signal processing component is a Band 66, Band 3, Band 40 triplexer having a passband of approximately 1800-2400 MHz. In another example, the second signal processing component is a balanced Band 7 filter having a passband of approximately 2620-2690 MHz.

In another example, the radio frequency multiplexer further comprises a phase shifting component coupled in series between the first signal processing component and the second signal processing component. In accordance with an aspect of this example, the first signal processing component is a Band 66, Band 3, Band 40 triplexer having a passband of approximately 1800-2400 MHz.

In one example, the coupling circuit includes a first switch coupled in series between the common signal node and the first signal processing component, the first switch being closed in the first mode of operation and open in the second mode of operation, and a second switch coupled in series between the common signal node and the second signal processing component, the second switch being closed in the second mode of operation. In accordance with this example, the coupling circuit may further include a third switch coupled in series between the first signal processing component and the second signal processing component, the third switch being open in the first mode of operation and closed in the second mode of operation. A further example may further comprise a phase shifting component coupled in series between the third switch and the second signal processing component. In at least one example, the first signal processing component is a Band 66, Band 3, Band 40 triplexer having a passband of approximately 1800-2400 MHz and the second signal processing component is a balanced Band 7 filter having a passband of approximately 2620-2690 MHz. In some examples, the coupling circuit further includes a shunt switch coupled to a reference potential and to the third switch and the phase shifting component, the shunt switch being closed in the first mode of operation and open in the second mode of operation. In at least one example, the first mode of operation is a non-carrier aggregation mode and the second mode of operation is a carrier aggregation mode.

According to another aspect of the present disclosure, a radio frequency multiplexer is provided. The radio frequency multiplexer comprises a common signal node to receive and/or transmit radio frequency signals, a first signal processing component configured to pass frequencies in a first band and to reject frequencies in a second band and in a third band, a second signal processing component configured to pass frequencies in the second band and to reject frequencies in the first band and in the third band, a third signal processing component configured to pass frequencies in the third band and to reject frequencies in the first band and in the second band, and a coupling circuit. The coupling circuit is coupled to the common signal node and the first, second, and third signal processing components. The coupling circuit is configured to couple one of the first signal processing component, the second signal processing component, and the third signal processing component to the common signal node in a first mode of operation, and to couple the third signal processing component to the common signal node in a second mode of operation with at least one of the first signal processing component and the second signal processing components being coupled in series with the third signal processing component.

In at least one example, the first signal processing component is a Band 40 filter having a passband of approximately 2300-2400 MHz, the second signal processing component is a Band 66, Band 3 duplexer having a passband of approximately 1800-2200 MHz, and the third signal processing component is a balanced Band 7 filter having a passband of approximately 2620-2690 MHz.

In one example, the radio frequency multiplexer further comprises a phase shifting component coupled in series with the first signal processing component, the second signal processing component, and the third signal processing component.

In at least one example, the coupling circuit includes a first switch coupled in series between the common signal node and the first signal processing component, the first switch being closed in the first mode of operation and open in the second mode of operation, a second switch coupled in series between the common signal node and the second signal processing component, the second switch being closed in the first mode of operation and open in the second mode of operation, and a third switch coupled in series between the common signal node and the third signal processing component, the third switch being closed in the second mode of operation.

In at least one example, the coupling circuit may further include a fourth switch coupled in series between the first signal processing component and the third signal processing component, the fourth switch being open in the first mode of operation and closed in the second mode of operation. In some examples, the coupling circuit further includes a fifth switch coupled in series between the second signal processing component and the third signal processing component, the fifth switch being open in the first mode of operation and closed in the second mode. of operation. In some examples, the radio frequency multiplexer further comprises a phase shifting component coupled in series between the fourth and fifth switches and the third signal processing component. In a further example, the coupling circuit further includes a shunt switch coupled between a reference potential, the fourth and fifth switches, and the phase shifting component, the shunt switch being closed in the first mode of operation and open in the second mode of operation. In at least one example, the first signal processing component is a Band 40 filter having a passband of approximately 2300-2400 MHz, the second signal processing component is a Band 66, Band 3 duplexer having a passband of approximately 1800-2200 MHz, and the third signal processing component is a balanced Band 7 filter having a passband of approximately 2620-2690 MHz. In accordance with this example, the first mode of operation is a non-carrier aggregation mode and the second mode of operation is a carrier aggregation mode. In a further example, the coupling circuit has a third mode configured to couple the first signal processing component to the common signal node in parallel with the second signal processing component, the third mode also being a carrier aggregation mode.

According to yet another aspect of the present disclosure, a radio frequency multiplexer is provided. The radio frequency multiplexer comprises a common signal node to receive and/or transmit radio frequency signals, a first bypass switch, a second bypass switch, a phase shifting component, and a first carrier aggregation switch. The first bypass switch is coupled between the common signal node and a first signal processing component having an open state and a closed state, the first signal processing component passing frequencies in a first band and rejecting frequencies in a second band. The second bypass switch is coupled between the common signal node and a second signal processing component having an open state and a closed state, the second signal processing component passing frequencies in the second band and rejecting frequencies in the first band. The phase shifting component is coupled in series between the first signal processing component and the second signal processing component, and the first carrier aggregation switch is coupled between the phase shifting component and the first signal processing component. The first carrier aggregation switch permits signals received from the common signal node and having the first frequency to be passed to the first signal processing component via the second signal processing component.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a block diagram of a front end module;

FIG. 2 is a schematic diagram of a multiplexer;

FIG. 3 is normalized Smith chart that provides a visual representation of an impedance;

FIG. 4A is a Smith chart that depicts the example impedance Zin1 of the multiplexer of FIG. 2 on the normalized Smith chart of FIG. 3;

FIG. 4B is a Smith chart that depicts the example impedance Zin2 of the multiplexer of FIG. 2 on the normalized Smith chart of FIG. 3

FIG. 5 is a schematic diagram of a multiplexer in accordance with aspects described herein;

FIG. 6 is a set of graphs illustrating performance of the multiplexer of FIG. 5 in accordance with aspects described herein;

FIG. 7 is a Smith chart illustrating performance of the multiplexer of FIG. 5 in accordance with aspects described herein; and

FIG. 8 is a schematic diagram of a multiplexer in accordance with aspects described herein.

### DETAILED DESCRIPTION

Aspects and examples are directed to multiplexers and components thereof, and to devices, modules, and systems incorporating same.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

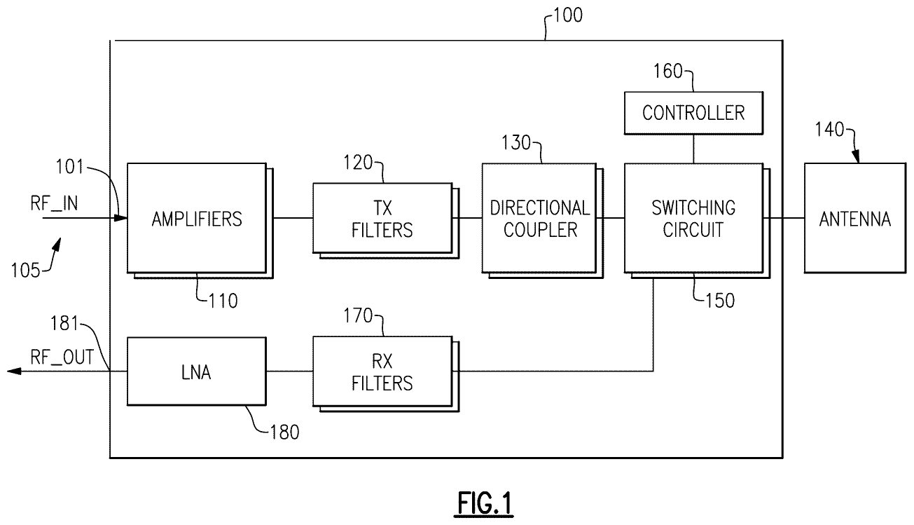

FIG. 1 is a block diagram illustrating an example of a typical arrangement of a radio-frequency (RF) “front-end” sub-system or module (FEM) 100 as may be used in a communications device, such as a mobile phone, for example, to transmit and receive RF signals. The FEM 100 shown in FIG. 1 includes a transmit path (TX) configured to provide signals to an antenna for transmission and a receive path (RX) to receive signals from the antenna. In the transmit path (TX), a power amplifier module 110 provides gain to an RF signal 105 input to the FEM 100 via an input port 101, producing an amplified RF signal. The power amplifier module 110 can include one or more Power Amplifiers (PA).

The FEM 100 can further include a transmit filtering subsystem or module 120, which can include one or more filters. A directional coupler 130 can be used to extract a portion of the power from the RF signal traveling between the power amplifier module 110 and an antenna 140 connected to the FEM 100. The antenna 140 can transmit the RF signal and can also receive RF signals. A switching circuit 150, also referred to as an Antenna Switch Module (ASM), can be used to switch between a transmitting mode and receiving mode of the FEM 100, for example, or between different transmit or receive frequency bands. In certain examples, the switching circuit 150 can be operated under the control of a controller 160. As shown, the directional coupler 130 can be positioned between the filtering subsystem 120 and the switching circuit 150. In other examples, the directional coupler 130 may be positioned between the power amplifier module 110 and the filtering subsystem 120, or between the switching circuit 150 and the antenna 140.

The FEM 100 can also include a receive path (RX) configured to process signals received by the antenna 140 and provide the received signals to a signal processor (e.g., a transceiver) via an output port 181. The receive path (RX) can include a receive filtering subsystem or module 170, which may include one or more filters, and one or more Low-Noise Amplifiers (LNA) 180 to amplify the signals received from the antenna 140.

In some cases, the transmit path (TX) and/or the receive path (RX) may be configured for multiple frequency bands (e.g., mid-bands, high-bands, etc.) to support carrier aggregation. As such, the FEM 100 may include one or more multiplexers to support multiple frequency bands. For example, a multiplexer may be coupled to the antenna port of the FEM 100 such that the FEM 100 can transmit and/or receive multiple frequency bands.

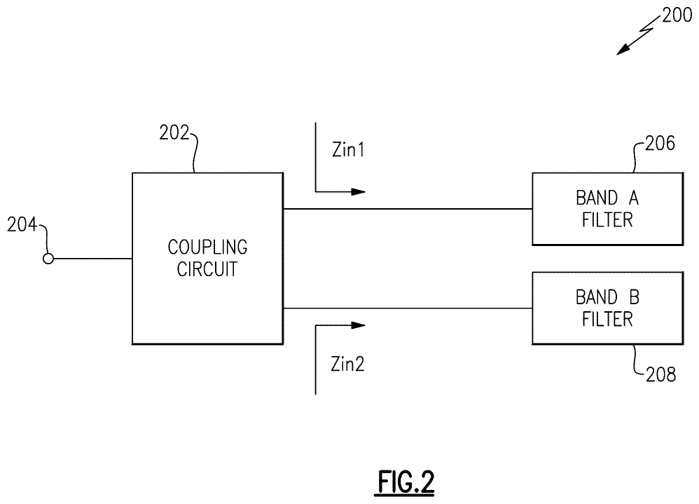

FIG. 2 is a block diagram of a multiplexer 200. In one example, the multiplexer 200 includes a coupling circuit 202. The coupling circuit 202 is shown to couple a common signal node 204 to a first signal processing component 206 (a Band A component such as a Band A filter) and a second signal processing component 208 (a Band B component such as a Band B filter). Configured in the foregoing manner, impedance Zin1 presented to the coupling circuit 202 can be equal to (or approximately equal to) a load impedance (e.g., 50 Ohm) of the Band A filter for a Band A signal, and be equal to (or approximately equal to) zero for a Band B signal. Similarly, impedance Zin2 presented to the coupling circuit 202 can be equal to (or approximately equal to) a load impedance (e.g., 50 Ohm) of the Band B filter for the Band B signal and be equal to (or approximately equal to) zero for the Band A signal.

The multiplexer 200 can be configured to couple the foregoing first and second signal paths associated with the Band A and Band B filters, such that the approximately zero impedance presented by the first signal path (with Band A filter) to the signal in the second frequency band (Band B signal) results in the signal in the second frequency band (Band B signal) being substantially excluded from the first signal path, and such that the approximately zero impedance presented by the second signal path (with Band B filter) to the signal in the first frequency band (Band A signal) results in the signal in the first frequency band (Band A signal) being substantially excluded from the second signal path.

In the example of FIG. 2, as well as some of the other examples described herein, impedances presented by respective filters are depicted in the context of a flow of signal(s) from a common signal node (204 in FIG. 2) to either or both of first and second signal paths associated with a first band (Band A) filter and a second band (Band B) filter. However, it should be appreciated that the flow of signal(s) can be in reverse relative to the foregoing configuration.

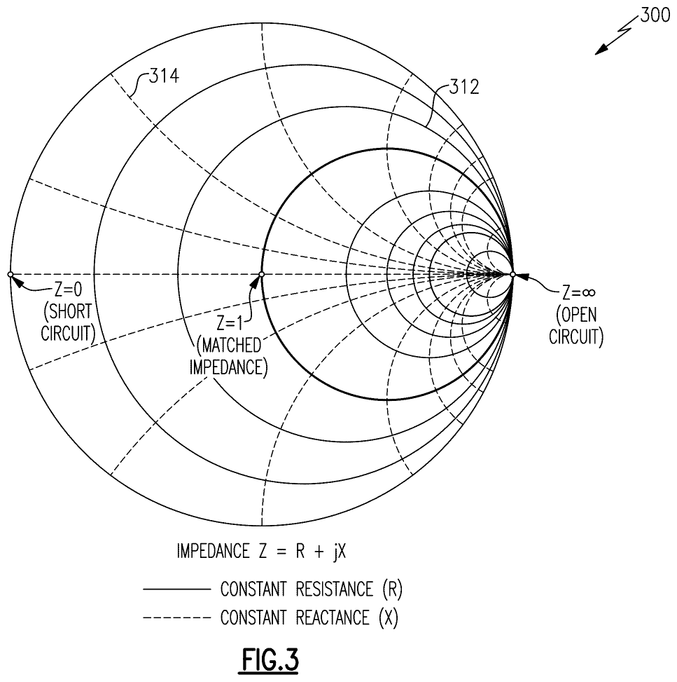

FIG. 3 is a normalized Smith chart 300 that provides a visual representation of an impedance Z=R+jX, where R is resistance and X is reactance. It is noted that for a pure capacitance, reactance X is equal to X_{C}=−1/ωC where ω=2πf, and for a pure inductance, reactance X is equal to X_{L}=ωL. Thus, for a pure resistance, Z=R; for a pure capacitance, Z=jXC=−j/ωC; and for a pure inductance, Z=jX_{L}=jωL. It is also noted that an impedance in the region above the horizontal line of the Smith chart 300 has a positive imaginary value and represents an inductive impedance, and an impedance in the region below the horizontal line of the Smith chart 300 has a negative imaginary value and represents a capacitive impedance.

Referring to FIG. 3, the foregoing horizontal line segment is shown to bisect the outermost circle, with the left end of the horizontal line segment representing a short circuit (Z=0) state, and the right end of the horizontal line segment representing an open circuit (Z=∞) state. The mid-point of the horizontal line segment (and thus the center of the outermost circle) represents a matched impedance state. Such a matched impedance state has a value of Z=1 in the normalized representation. In an un-normalized representation, such a matched impedance state can have a value of, for example, Z=50 ohms.

In the normalized Smith chart 300 of FIG. 3, solid-line circles are constant-resistance circles 312 at example normalized values. For example, the outermost circle referenced above has a constant-resistance value of 0, and the successively smaller circles have constant-resistance values of 0.2, 0.5, 1, 2, 3, 4, 5 and 10. All of such constant-resistance circles share their right-most points at the right end of the above-referenced horizontal line segment (open circuit state). In the normalized Smith chart 300 of FIG. 3, dashed-line arcs are constant-reactance arcs 314 at example normalized values. For example, the above-referenced horizontal line segment (an arc of an infinite-radius circle) has a constant-reactance value of 0, and the successively smaller-radius-circle arcs have constant-reactance values of 0.2, 0.5, 1, 2, 3, 4, 5 and 10. Such constant reactance arcs can be provided above and below the horizontal line segment. For the arcs above the horizontal line segment, the arcs share their lower-most points at the right end of the horizontal line segment (open circuit state). For the arcs below the horizontal line segment, the arcs share their upper-most points at the right end of the horizontal line segment (open circuit state).

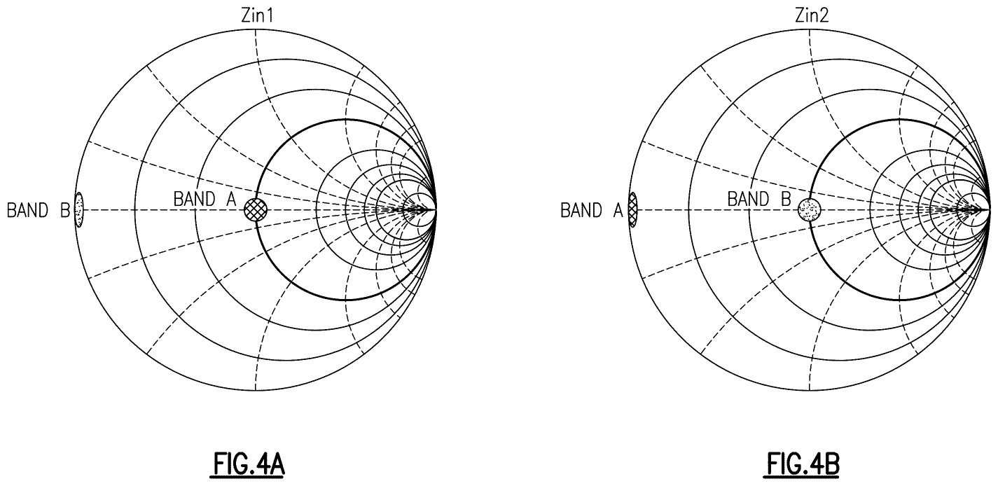

FIGS. 4A and 4B depict the example impedances Zin1 and Zin2 of FIG. 2, respectively, on the normalized Smith chart of FIG. 3. More particularly, FIG. 4A shows Zin1 having an impedance region at or about the matched impedance state (Z=1+i0) that includes impedance values associated with a frequency range of the first frequency band (Band A), and an impedance region at or about the short circuit state (Z=0+i0) that includes impedance values associated with a frequency range of the second frequency band (Band B). Similarly, FIG. 4B shows Zin2 having an impedance region at or about the matched impedance state (Z=1+i0) that includes impedance values associated with the frequency range of the second frequency band (Band B), and an impedance region at or about the short circuit state (Z=0+i0) that includes impedance values associated with the frequency range of the first frequency band (Band A).

While the multiplexer 200 is described above as providing optimized impedances for two bands (e.g., Band A and Band B), the multiplexer 200 may experience performance degradation if configured to support more than two bands. For example, as additional paths and components (e.g., filters) are added, the losses experienced in each path (and in each band) may increase due to loading and impedance mismatches. In addition, to provide the optimized impedances, each path of the multiplexer may include phase shifters, which can further increase the losses experienced in each path (and in each band).

As such, an improved multiplexer is provided herein. In at least one embodiment, the multiplexer includes a balanced filter configured to provide optimized impedances for multiple frequency bands with minimal loss. In some examples, the multiplexer includes a plurality of switches and a phase shifter to provide the optimized impedances at the balanced filter.

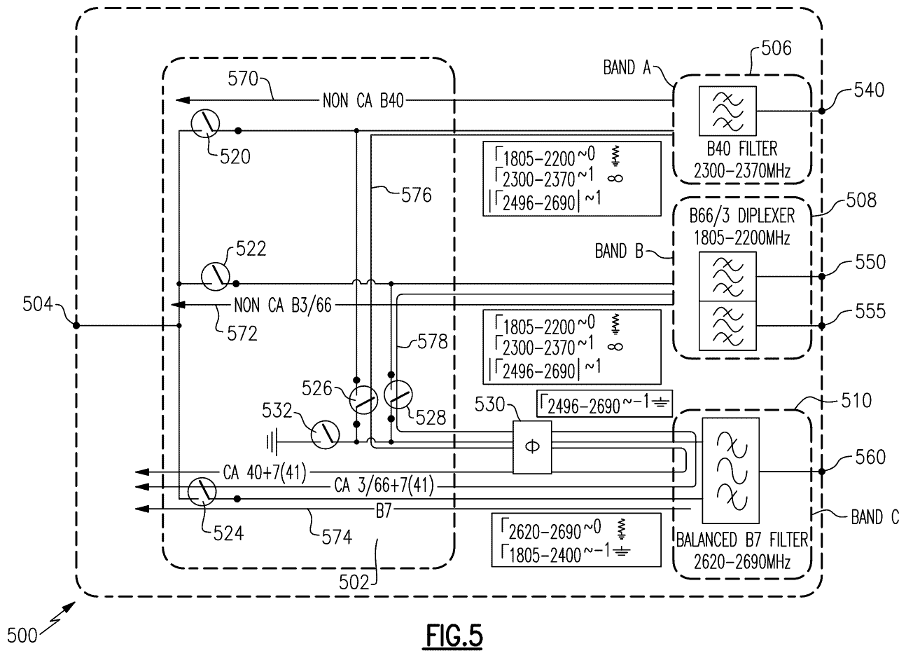

FIG. 5 is a schematic diagram of a multiplexer in accordance with aspects described herein. The multiplexer 500 includes a coupling circuit 502 and a plurality of signal processing components 506, 508, and 510. The coupling circuit 502 is shown to couple a common signal node 504, such as an antenna node or port, to a first signal processing component 506 (a Band A component, such as a Band A filter), a second signal processing component 508 (a Band B component, such as a Band B filter), and a third signal processing component 510 (a Band C component, such as a Band C filter). The coupling circuit 502 incudes a plurality of bypass switches 520, 522, 524 and one or more Carrier Aggregation (CA) switches 526, 528. Each of the first, second, and third signal processing components are coupled to one or more respective ports 540, 550/555, 560 that may be routed to a LNA amplifier, to a power amplifier (which may include one or more power amplifiers), or both. A phase shifting component 530 is coupled in series between the third signal processing component 510 and the first and second signal processing components 506, 508, such that in certain configurations (e.g., CA switches 526 and 528 closed), the first and second signal processing components 506, 508 are each in series with the third signal processing component 510 and the phase shifting component 530 and in parallel with one another.

As shown, the various filters may be Frequency Domain Duplexing (FDD) filters (Bands B and C), or Time Domain Duplexing (TDD) filters (Band) A. Moreover the filters may be configured as a single filter, a diplexer, or a balanced filter. In the example of FIG. 5, the Band A filter 506 is configured as a Band 40 TDD filter having a passband of about 2300 to 2370 MHz and may be used to transmit or receive a Band 40 frequency signal, the Band B filter 508 is configured as a Band 66/Band 3 FDD Diplexer having a passband of approximately 1805 to 2200 MHz, and the Band C filter is configured as a balanced Band 7 FDD filter having a passband of approximately 2620 to 2690 MHz. The Band B filter is configured to receive Band 66 and/or Band 3 signals and the Band C filter is configured to receive Band 7 signals. Preferably the Band C filter has good common mode rejection when used for transmission.

In non-CA communication modes one of bypass switches 520, 522, and 524 is closed and the other two are open. For example, when the first bypass switch 520 is closed, B40 transmit signals may be filtered by the first signal processing component 506 and provided via first path 570 to common signal node 504, which may be coupled to one or more antennas. B40 receive signals may be received from the common signal node 504, provided via first path 570 to the first signal processing component 506 to be filtered by the first signal processing component 506, and provided to port 540. During operation in non-CA mode in Band B40, the second bypass switch 522, the third bypass switch 524, and the first CA switch 526 would be open, and the shunt switch 532 would be closed. Second CA switch 528 may be open.

When the second bypass switch 522 is closed, B66 and/or B3 receive signals may be received from the common signal node 504, provided via second path 572 to the second signal processing component 508 to be filtered by the second signal processing component 508, and provided to ports 550 or 555. During operation in non-CA mode in Band B66/3, the first bypass switch 520, the third bypass switch 524, and the second CA switch 528 would be open, and the shunt switch 532 would be closed. First CA switch 526 may be open.

When the third bypass switch 524 is closed, B7 receive signals may be received from the common signal node 504, provided via third path 574 to the third signal processing component 510 to be filtered by the third signal processing component 510, and provided to port 560. During operation in non-CA mode in Band B7, the first bypass switch 520 and the second bypass switch 522 would be open as would be both the first CA switch 526 and the second CA switch 528, and the shunt switch 532 would be in a closed position.

As noted previously, first signal processing component 506 passes Band A signals (Γ)≈0) and reflects Band B signals (Γ≈1). First signal processing component 506 presents an impedance corresponding to a high reflection coefficient magnitude at Band C (|Γ|≈1), which is further processed through a phase shifter 530 to represent a short circuit impedance at Band C. Similarly, second signal processing component 508 passes Band B signals (Γ≈0), reflects Band A signals (Γ≈1), and presents an impedance corresponding to a high reflection coefficient magnitude at Band C (|Γ|≈1), which is further processed through a phase shifter 530 to represent a short circuit impedance at Band C. Third signal processing component 510 passes Band C signals (Γ≈0), and reflects signals falling within Bands A or B, but with a 180 degree phase shift (Γ≈−1). Phase shifting component 530 provides a certain amount of phase shift at frequencies between about 2496 MHz and 2690 MHz, which encompasses Band 7 and also Band 41.

In CA mode, either the first and second bypass switches 520 and 522 are closed and third bypass switch 524 is open, or both first and second bypass switches 520 and 522 are open and third bypass switch 524 is closed. For example, when first and second bypass switches 520 and 522 are both closed and third bypass switch 524 is open, carrier aggregation may be performed in Bands B40 and B66/3. In this configuration, the first and second CA switches 526 and 528 may be open and shunt switch 532 closed. With such a configuration, signals received at the common signal node 504 in Band A may be routed along path 570 to the first signal processing component 506, and signals received at the common signal node 504 in Band B may be routed along path 572 to the second signal processing component 508.

Alternatively, in CA mode, when first and second bypass switches 520 and 522 are open and third bypass switch 524 is closed, carrier aggregation may be performed amongst Bands B40 and B7, B66/3 and B7, or Band B40, B66/3, and B7 depending upon the positions of CA switch 526 and 528. For example, when the third bypass switch 524 is closed, first bypass switch 520 and second bypass switch may be open, first CA switch 526 closed, shunt switch 532 open, and second CA switch 528 either open or closed. With such a configuration, signals received at the common signal node 504 in Band A are provided to the third signal processing component 510, and from the third processing component 510 through the phase shifting component 530 via the closed first CA switch 526 to the first signal processing component 506 corresponding to Band A along first CA path 576 and to the first port 540. Conversely, signals transmitted via port 540 to the first signal processing component in Band 40 are routed along path 576 via the phase shifting component 530 to the third signal processing component 510 and from the third signal processing component to the common signal node 504. CA signals received at the common signal node 504 in Band C are provided to the third processing component 510, and via the third signal processing component 510 to the third port 560 via path 574.

Alternatively, when third bypass switch 524 is closed, first and second bypass switches 520 and 522 are open, shunt switch 532 is open, second CA switch 528 is close, and first bypass switch 526 is either open or closed, CA signals in Band B received at the common signal node 504 are provided to the third signal processing component 510, from the third processing component to the phase shifting component 530 and via the closed second CA switch 528 to the second signal processing component 508 and one of ports 550 and 555 (depending on whether the Band B signal is a Band 66 signal or a Band 3 signal) corresponding to Band B along second CA path 578. CA signals received at the common signal node 504 in Band C are provided to the third processing component 510, and via the third signal processing component 510 to the third port 560 via path 574.

Alternatively still, in CA mode, third bypass switch 524 may be closed, first and second bypass switches 520 and 522 may be open, shunt switch 532 may be open, and first and second CA switches 526 and 528 may be closed. In such a configuration, signals received in Bands A, B, and C may be received at the common signal node 504 and provided via paths 574, 576, and 578, to each of the third, first and second signal processing components 510, 506, 508, and signals transmitted in Band A may be provided via path 576 to the common signal node 504.

As discussed above, during operation in CA mode, the third signal processing component 510 is in series with the phase shifting component 530, and also in series with the first signal processing component 506 and the second signal processing component 508. During operation in CA mode, the combination of the third signal processing component 510 and the phase shifting component 530 acts as a short to frequencies in Bands A and B, allowing these frequencies to be provided, via paths 576 and 578 to the first and second signal processing components 506, 508 with little additional attenuation. That is, each of first and second signal processing components 506, 508 presents a reflection coefficient Gamma (Γ) with a magnitude of about 1 at band C. Phase shifter 530 rotates the phase of the Gamma to 180, which is equivalent to a short impedance. It should be noted that given the passband of the third signal processing component 510, and the reflection coefficient of first and second signal processing components 506 and 508, frequencies within Band 41 may also be transmitted and received via path 574.

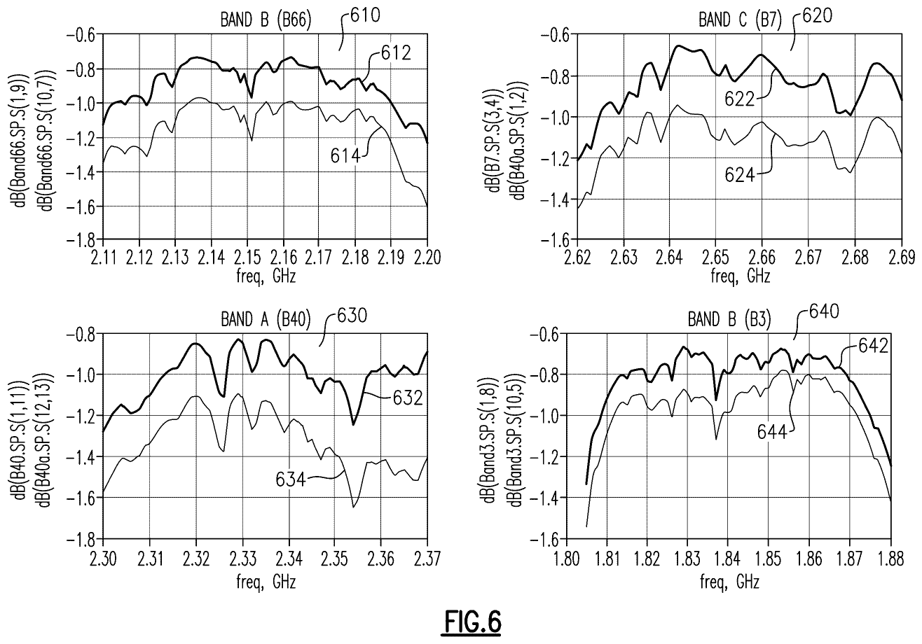

FIG. 6 illustrates a number of graphs illustrating the performance of the multiplexer of FIG. 5 and showing the insertion loss at various frequencies corresponding to each of Bands 66, 7, 40, and 3. The first graph 610 illustrates the insertion loss of the multiplexer of FIG. 5 when used in a non-CA mode (plot 612) versus a CA mode (plot 614) with frequencies within Band 66. Graph 620 illustrates the insertion loss of the multiplexer of FIG. 5 when used in the non-CA mode (plot 622) versus the CA mode (plot 624) with frequencies within Band 7, graph 630 illustrates the insertion loss of the multiplexer of FIG. 5 when used in the non-CA mode (plot 632) versus the CA mode (plot 634) with frequencies within Band 40, and graph 640 illustrates the insertion loss of the multiplexer of FIG. 5 when used in the non-CA mode (plot 642) versus the CA mode (plot 644) with frequencies within Band 3. As shown in FIG. 6, the difference in insertion loss between operation in the non-CA mode versus the CA mode is about 0.4 dB across the various frequency bands. This is in contrast to conventional solutions using phase shifting components in each path which typically impose insertion losses greater than 1 dB per path.

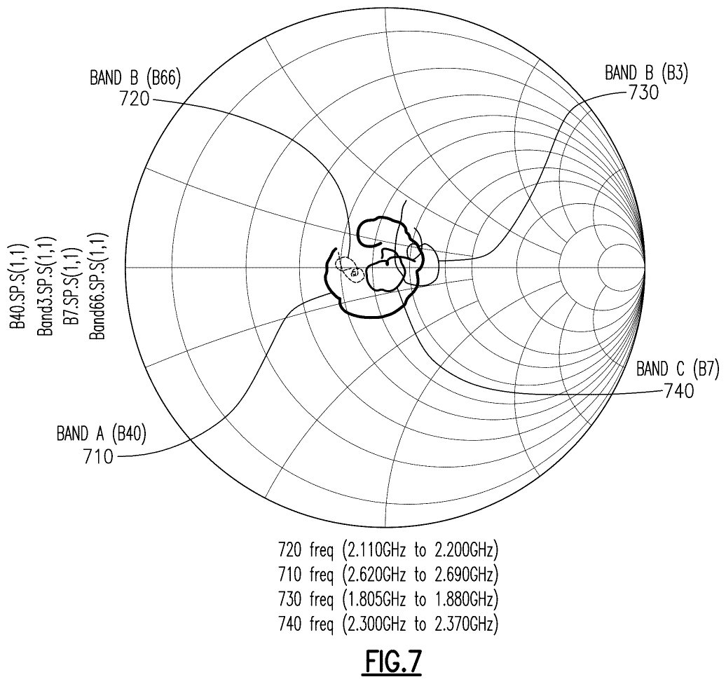

FIG. 7 is a Smith chart illustrating performance of the multiplexer of FIG. 5 in accordance with aspects described herein. As shown in FIG. 7, the normalized impedance for each of the frequency bands in CA mode is approximately 1 for Band A 710, Band B 720,730, and Band C 740, with relatively little inductive or capacitive impedance.

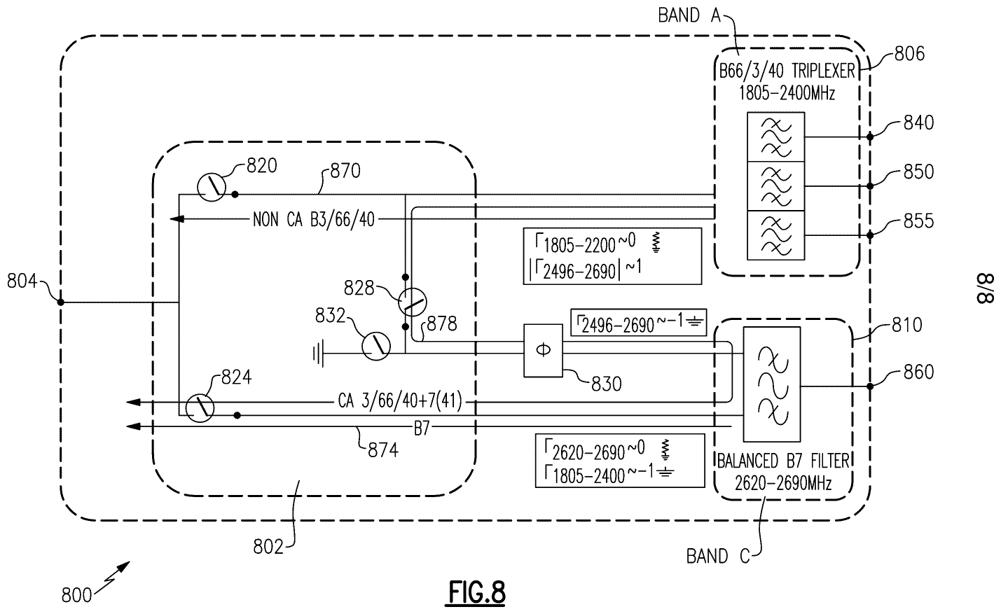

FIG. 8 is a schematic diagram of another multiplexer in accordance with aspects described herein. The multiplexer 800 illustrated in FIG. 8 is similar to the multiplexer 500 of FIG. 5 but uses fewer components.

The multiplexer 800 includes a coupling circuit 802 and a plurality of signal processing components 806, and 810. The coupling circuit 802 is shown to couple a common signal node 804, such as an antenna node or port, to a first signal processing component 806 (a Band A component, such as a Band A filter), and a second signal processing component 808 (a Band B component, such as a Band B filter). The coupling circuit 802 incudes a plurality of bypass switches 820, 824, and at least one Carrier Aggregation (CA) switch 828. Each of the first and second signal processing components 806, 810 are coupled to a respective port 840, 850, 855, 860 that may be routed to an LNA amplifier, to a power amplifier (which may include one or more power amplifiers), or both. A phase shifting component 830 is coupled in series between the second signal processing component 810 and the first signal processing component 806, such that in certain configurations (e.g., CA switch 828 closed), the first signal processing component 806 is in series with the second signal processing component 810 and the phase shifting component 830.

As shown, the various filters may be Frequency Domain Duplexing (FDD) filters or Time Domain Duplexing (TDD) filters, or various combinations thereof. Moreover the filters may be configured as a single filter, a diplexer, a triplexer, or a balanced filter. In the example of FIG. 8, the Band A filter 806 is configured as a Band 66/Band 3/Band 40 triplexer filter having a passband of about 1805 to about 2400 MHz and may be used to transmit or receive Band 40 frequency signals, to receive Band 66 signals, or to receive Band 3 signals. For example, Band 40 signals may be transmitted or received via port 840, Band 66 signals may be received via port 850, and Band 3 signals may be received via port 855. The Band C filter is configured as a balanced Band 7 FDD filter having a passband of approximately 2620 to 2690 MHz, and preferably has good common mode rejection when used for transmission.

The first bypass switch 820 of the coupling circuit 802 may be opened for use in a Carrier Aggregation (CA) communication mode or closed for use in non-CA communication mode. For example, when the first bypass switch 820 is closed, B40, B66, and/or B3 signals received at the common signal node 804 may be filtered by the first signal processing component 806 and provided via first path 870 to ports 840, 850, or 855. Transmitted B40 signals may be provided via first signal processing component 806 via path 870 to the common signal node 804, which may be coupled to one or more antennas. During operation in non-CA mode, the CA switch 828 would be open, the shunt switch 832 would be closed, and the second bypass switch 824 would be open.

When the second bypass switch 824 is closed, the multiplexer may be in a CA mode or a non-CA mode. In the non-CA mode, with the bypass switch 824 closed, Band B7 signals may be received at common signal node 804 and provided to second signal processing component 810 where they may then be provided to port 860. In the non-CA mode, shunt switch 832 would be closed. Bypass switch 820 would be open, as would CA switch 828 with Band B7 being provided via path 874 to port 860. In the CA mode of operation, bypass switch 824 would again be closed, but shunt switch 832 and bypass switch 820 would be open, and the CA switch 828 would be closed. In such a configuration, Band B40 signals transmitted on port 840 would be provided via path 878 to the common signal node 804, and Band 7 and Band 40, 66, and/or 3 signals received via common signal node 804, would be provided via paths 874 and 878 to second and first signal processing components 810 and 806, respectively. For example, in the CA mode with bypass switch 824 closed, bypass switch 820 open, shunt switch 832 open and CA switch 828 closed, signals received in any of Bands B7, B66, B3, and/or B40 would be received at common signal node 804, and provided via path 874 to the second signal processing component 810. From the second signal processing component 810, the Band B7 signal would be provided to port 860, and the Band 66, 3, and/or 40 signals would be provided from the second signal processing component 810 to the phase shifting component 830, and from the phase shifting component 830 via path 878 to the first signal processing component 806 where they would then be provided to one of ports 840, 850 and 855.

In CA mode, the second bypass switch 824 is closed, shunt switch 832 is open, bypass switch 820 is open, and CA switch 828 is closed. With such a configuration, CA signals received at common signal node 804 in Band A may be received at the common signal node 804 and provided to the second signal processing component 810. For example, Band A signals received at the common signal node 804 are provided to the second signal processing component 810, and from the second processing component 810 through the phase shifting component 830 via the closed first CA switch 828 to the first signal processing component 806 corresponding to Band A along first CA path 878. CA signals received at the common signal node 804 in Band C are provided to the second processing component 810, and via the second signal processing component 810 to the port 860. Transmitted signals in Band A provided to port 840 may be provided to the phase shifting component 830 via path 878 to the second signal processing component 810 and then to the common signal node 804.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A radio frequency multiplexer comprising:
a common signal node to receive and/or transmit radio frequency signals;
a first signal processing component configured to pass frequencies in a first band and to reject frequencies in a second band;
a second signal processing component configured to pass frequencies in the second band and to reject frequencies in the first band; and
a coupling circuit coupled to the common signal node and the first and second signal processing components, the coupling circuit being configured to couple the first signal processing component and the second signal processing component to the common signal node and in parallel with one another in a first mode of operation, and to couple only the second signal processing component to the common signal node in a second mode of operation with the second signal processing component being coupled in series with the first signal processing component between the first signal processing component and the common signal node.

2. The radio frequency multiplexer of claim 1 further comprising a phase shifting component coupled in series between the first signal processing component and the second signal processing component.

3. The radio frequency multiplexer of claim 2 wherein the first signal processing component is a Band 66, Band 3, Band 40 triplexer having a passband of approximately 1800-2400 MHz and the second signal processing component is a balanced Band 7 filter having a passband of approximately 2620-2690 MHz.

4. The radio frequency multiplexer of claim 1 wherein the coupling circuit includes:
a first switch coupled in series between the common signal node and the first signal processing component, the first switch being closed in the first mode of operation and open in the second mode of operation; and
a second switch coupled in series between the common signal node and the second signal processing component, the second switch being closed in the second mode of operation.

5. The radio frequency multiplexer of claim 4 wherein the coupling circuit further includes a third switch coupled in series between the first signal processing component and the second signal processing component, the third switch being open in the first mode of operation and closed in the second mode of operation.

6. The radio frequency multiplexer of claim 5 further comprising a phase shifting component coupled in series between the third switch and the second signal processing component.

7. The radio frequency multiplexer of claim 6 wherein the first signal processing component is a Band 66, Band 3, Band 40 triplexer having a passband of approximately 1800-2400 MHz.

8. The radio frequency multiplexer of claim 6 wherein the second signal processing component is a balanced Band 7 filter having a passband of approximately 2620-2690 MHz.

9. The radio frequency multiplexer of claim 8 wherein the coupling circuit further includes a shunt switch coupled to a reference potential and to the third switch and the phase shifting component, the shunt switch being closed in the first mode of operation and open in the second mode of operation.

10. The radio frequency multiplexer of claim 9, wherein the first mode of operation is a non-carrier aggregation mode and the second mode of operation is a carrier aggregation mode.

11. A radio frequency multiplexer comprising:
a common signal node to receive and/or transmit radio frequency signals;
a first signal processing component configured to pass frequencies in a first band and to reject frequencies in a second band and in a third band;
a second signal processing component configured to pass frequencies in the second band and to reject frequencies in the first band and in the third band;
a third signal processing component configured to pass frequencies in the third band and to reject frequencies in the first band and in the second band;
a coupling circuit coupled to the common signal node and the first, second, and third signal processing components, the coupling circuit being configured to couple one of the first signal processing component, the second signal processing component, and the third signal processing component to the common signal node in a first mode of operation, and to couple the third signal processing component to the common signal node in a second mode of operation with at least one of the first signal processing component and the second signal processing components being coupled in series with the third signal processing component.

12. The radio frequency multiplexer of claim 11 further comprising a phase shifting component coupled in series with the first signal processing component, the second signal processing component, and the third signal processing component.

13. The radio frequency multiplexer of claim 11 wherein the coupling circuit includes:
a first switch coupled in series between the common signal node and the first signal processing component, the first switch being closed in the first mode of operation and open in the second mode of operation;
a second switch coupled in series between the common signal node and the second signal processing component, the second switch being closed in the first mode of operation and open in the second mode of operation; and
a third switch coupled in series between the common signal node and the third signal processing component, the third switch being closed in the second mode of operation.

14. The radio frequency multiplexer of claim 13 wherein the coupling circuit further includes a fourth switch coupled in series between the first signal processing component and the third signal processing component, the fourth switch being open in the first mode of operation and closed in the second mode of operation.

15. The radio frequency multiplexer of claim 14 wherein the coupling circuit further includes a fifth switch coupled in series between the second signal processing component and the third signal processing component, the fifth switch being open in the first mode of operation and closed in the second mode. of operation.

16. The radio frequency multiplexer of claim 15 further comprising a phase shifting component coupled in series between the fourth and fifth switches and the third signal processing component.

17. The radio frequency multiplexer of claim 16 wherein the coupling circuit further includes a shunt switch coupled between a reference potential, the fourth and fifth switches, and the phase shifting component, the shunt switch being closed in the first mode of operation and open in the second mode of operation.

18. The radio frequency multiplexer of claim 17 wherein the first signal processing component is a Band 40 filter having a passband of approximately 2300-2400 MHz.

19. The radio frequency multiplexer of claim 18 wherein the second signal processing component is a Band 66, Band 3 duplexer having a passband of approximately 1800-2200 MHz.

20. The radio frequency multiplexer of claim 19 wherein the third signal processing component is a balanced Band 7 filter having a passband of approximately 2620-2690 MHz.
